(19) United States
(12) Patent Application Publication
(10) Pub. No.: US 2020/0298887 A1
(43) Pub. Date: Sep. 24, 2020

(54) VEHICLE, CONTROL SYSTEM OF VEHICLE, AND CONTROL METHOD OF VEHICLE

(71) Applicant: HONDA MOTOR CO., LTD., Tokyo (JP)

(72) Inventor: Takuyuki MUKAI, Wako-shi (JP)

(21) Appl. No.: 16/894,671

(22) Filed: Jun. 5, 2020

Related U.S. Application Data
(63) Continuation of application No. PCT/JP2018/043408, filed on Nov. 26, 2018.

(30) Foreign Application Priority Data
Dec. 13, 2017 (JP) PCT/JP2017/044660

(51) Int. Cl. B60W 60/00

(52) U.S. Cl. CPC B60W 60/0059; B60W 60/0027; B60W 2540/229; B60W 60/0053; B60W 2554/4041; B60W 60/0018

(57) ABSTRACT

A control system of a vehicle includes an external world recognition apparatus group and an actuator group. The control system comprises a traveling control unit configured to perform automated driving or traveling support by controlling the actuator group based on recognition results of the external world recognition apparatus group, and a monitoring unit configured to monitor a detected situation of a target by the external world recognition apparatus group as a control result of the actuator group. The monitoring unit determines whether or not the automated driving or the traveling support can be continued, based on the detected situation of the target.

### CROSS-REFERENCE TO RELATED APPLICATION(S)

This application is a continuation of International Patent Application No. PCT/JP2018/043408 filed on Nov. 26, 2018, which claims priority to and the benefit of International Patent Application No. PCT/JP2017/044660 filed on Dec. 13, 2017, the entire disclosures of which are incorporated herein by reference.

### TECHNICAL FIELD

The present invention relates to a vehicle, a control system of the vehicle, and a control method of the vehicle.

### BACKGROUND ART

Various technologies for achieving automated driving of a vehicle have been proposed. In PTL 1, a monitoring apparatus is provided for monitoring whether or not various kinds of control by an automated driving control apparatus is normally operating. The monitoring apparatus compares its own control calculation result with a control calculation result by the automated driving control apparatus, and when both control calculation results do not match, forcibly cancels an automatic control function by the automated driving control apparatus.

### CITATION LIST

### Patent Literature

### PTL 1: International Publication No. 2016/080452

### SUMMARY OF INVENTION

### Technical Problem

Even when it is determined by the monitoring apparatus of PTL 1 that the automatic control function is operating normally, there may be a case where the actual behavior of a vehicle is not normal. Some aspects of the present invention provide a technique for accurately determining deterioration of the traveling control function of the vehicle.

### Solution to Problem

According to some embodiments, there is provided a control system of a vehicle including an external world recognition apparatus group and an actuator group, the control system comprising: a traveling control unit configured to perform automated driving or traveling support by controlling the actuator group based on recognition results of the external world recognition apparatus group; and a monitoring unit configured to monitor a detected situation of a target by the external world recognition apparatus group as a control result of the actuator group, wherein the monitoring unit determines whether or not the automated driving or the traveling support can be continued, based on the detected situation of the target.

### Advantageous Effects of Invention

According to the present invention, deterioration of the traveling control function of a vehicle can be accurately determined.

Other features and advantages of the present invention will be apparent from the following description taken in conjunction with the accompanying drawings. Note that the same reference numerals denote the same or like components throughout the accompanying drawings.

### BRIEF DESCRIPTION OF DRAWINGS

The accompanying drawings are included in the specification, constitute a part of the specification, illustrate embodiments of the present invention, and are used for describing the principle of the present invention together with the description of the drawings.

FIG. 1 is a block diagram of a vehicle control system according to an embodiment.

FIG. 2 is a block diagram of the vehicle control system according to the embodiment.

FIG. 3 is a block diagram of the vehicle control system according to the embodiment.

FIG. 4 is a flowchart for describing a vehicle control method according to an embodiment.

FIG. 5 is a schematic diagram for describing the vehicle control method according to the embodiment.

FIG. 6 is a flowchart for describing the vehicle control method according to the embodiment.

### DESCRIPTION OF EMBODIMENTS

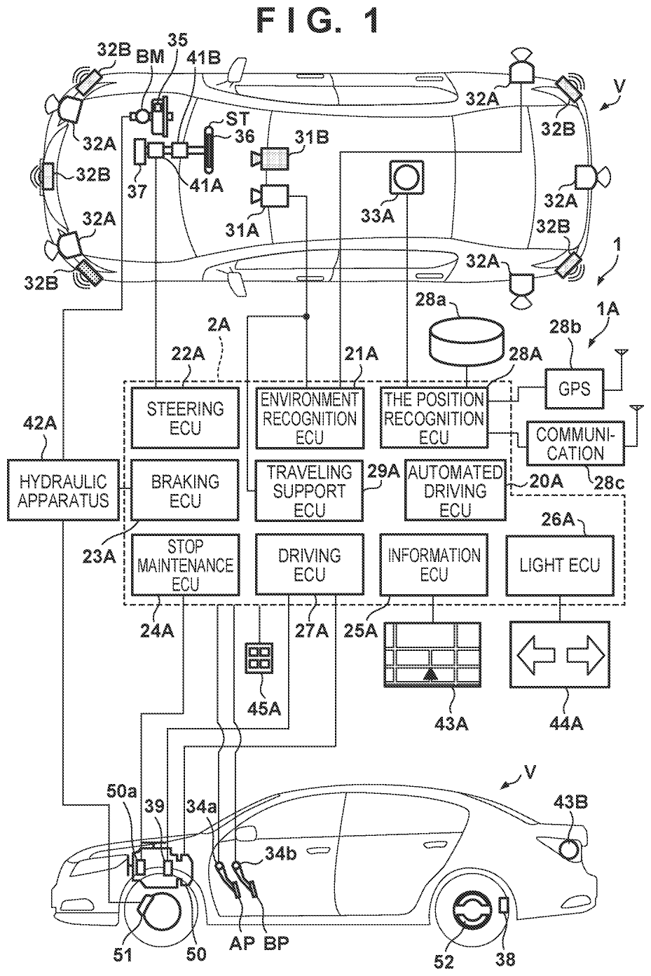

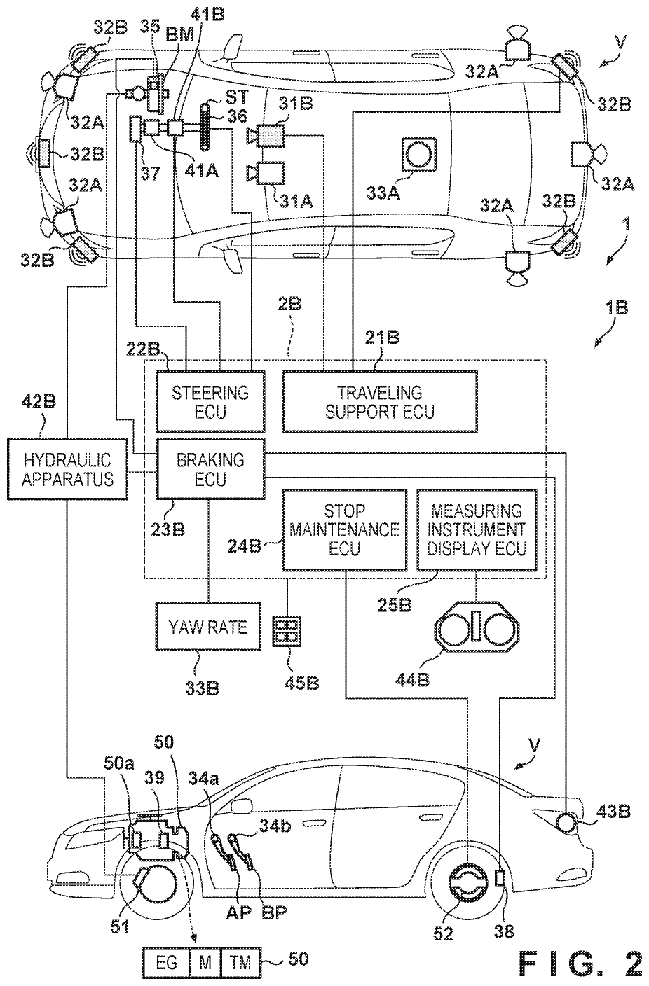

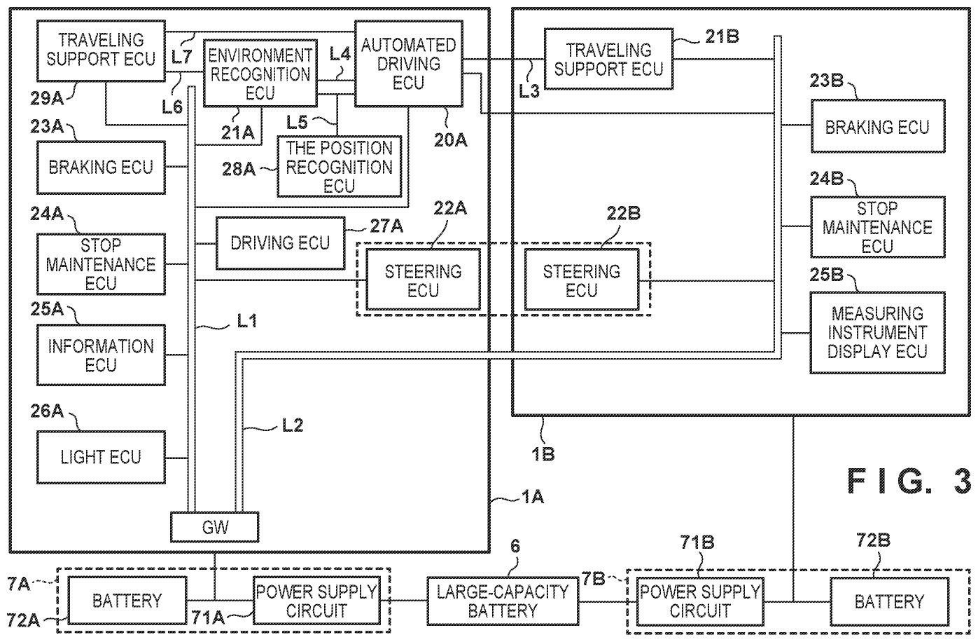

FIG. 1 to FIG. 3 are block diagrams of a vehicle control system 1 according to one embodiment of the present invention. The control system 1 controls a vehicle V. In FIG. 1 and FIG. 2, the outline of the vehicle V is illustrated in a plan view and a side view. As an example, the vehicle V is a sedan-type four-wheeled passenger car. The control system 1 includes a control apparatus 1A and a control apparatus 1B. FIG. 1 is the block diagram illustrating the control apparatus 1A, and FIG. 2 is the block diagram illustrating the control apparatus 1B. FIG. 3 mainly illustrates the communication line between the control apparatus 1A and the control apparatus 1B, and the configuration of a power source.

A part of functions achieved by the vehicle V are multiplexed or made redundant in the control apparatus 1A and the control apparatus 1B. Accordingly, the reliability of the system can be improved. The control apparatus 1A also performs traveling support control in connection with risk avoiding, etc., in addition to automated driving control, and usual operation control in manual driving, for example. The control apparatus 1B mainly administers the traveling support control in connection with risk avoiding, etc. The traveling support may be called driving support. It is possible to perform distribution of control processing and to improve reliability by making the control apparatus 1A and the control apparatus 1B redundant, and perform different control processing.

The vehicle V of the present embodiment is a parallel-type hybrid vehicle, and FIG. 2 schematically illustrates the configuration of a power plant 50 that outputs a driving force for rotating driving wheels of the vehicle V. The power plant 50 includes an internal combustion engine EG, a motor M, and an automatic transmission TM. The motor M can be utilized as a driving source for accelerating the vehicle V, and can also be utilized as an electric generator at the time of deceleration, etc. (regenerative braking).

<Control Apparatus 1A>

Referring to FIG. 1, the configuration of the control apparatus 1A will be described. The control apparatus 1A includes an ECU group (control unit group) 2A. The ECU group 2A includes a plurality of ECUs 20A to 29A. Each ECU includes a processor represented by a CPU, a storage device such as a semiconductor memory, an interface with an external device, etc. The storage device stores a program executed by the processor, data used by the processor for processing, etc. Each ECU may include a plurality of processors, storage devices, interfaces, etc. Note that the number of the ECUs and the functions to be handled can be properly designed, and these can be more subdivided or integrated than in the present embodiment. Further, in FIG. 1 and FIG. 3, typical function names are assigned to the ECU 20A to 29A. For example, the ECU 20A is shown as “automated driving ECU”.

The ECU 20A performs control in connection with automated driving as traveling control of the vehicle V. In automated driving, at least one of driving (acceleration of the vehicle V by the power plant 50, etc.), steering or braking of the vehicle V is automatically performed, without depending on a driver's operation. In the present embodiment, driving, steering, and braking are automatically performed.

The ECU 21A is an environment recognition unit that recognizes the traveling environment of the vehicle V, based on detection results of detection units 31A and 32A that detect the surrounding conditions of the vehicle V. The ECU 21A generates target data, which will be described later, as peripheral environment information.

In the case of the present embodiment, the detection unit 31A is an imaging device (hereinafter may be denoted as the camera 31A) that detects an object around the vehicle V by imaging. The camera 31A is provided in a front portion of a roof of the vehicle V, so as to be able to image the front of the vehicle V. By analyzing of the image imaged by the camera 31A, it is possible to extract the outline of a target, and to extract the compartment lines (white lines, etc.) of lanes on a road.

In the case of the present embodiment, the detection unit 32A is a lidar (Light Detection and Ranging) (hereinafter may be denoted as the lidar 32A) that detects an object around the vehicle V by light, detects a target around the vehicle V, and measures the distance to the target. In the case of the present embodiment, five lidars 32A are provided: one in each corner of a front portion of the vehicle V; one in the middle of a rear portion; and one in each side of the rear portion. The number and arrangement of the lidars 32A can be properly selected.

The ECU 29A is a traveling support unit that performs control in connection with traveling support (in other words, driving support) as traveling control of the vehicle V, based on the detection result of the detection unit 31A.

The ECU 22A is a steering control unit that controls an electric power steering apparatus 41A. The electric power steering apparatus 41A includes a mechanism that steers front wheels according to the driver's operation (steering operation) with respect to a steering wheel ST. The electric power steering apparatus 41A assists the steering operation, and includes a motor that exhibits the driving force for automatically steering the front wheels, a sensor that detects the rotation amount of the motor, a torque sensor that detects the steering torque to be exerted on the driver, etc.

The ECU 23A is a braking control unit that controls a hydraulic apparatus 42A. The hydraulic apparatus 42A achieves, for example, ESB (electric servo brake). The braking operation by the driver with respect to a brake pedal BP is converted into hydraulic pressure in a brake master cylinder BM, and is transmitted to the hydraulic apparatus 42A. The hydraulic apparatus 42A is an actuator that can control the hydraulic pressure of a working fluid to be supplied to a brake apparatus (for example, a disc brake apparatus) 51 provided for each of four wheels, based on the hydraulic pressure transmitted from the brake master cylinder BM, and the ECU 23A performs drive control of an electromagnetic valve provided in the hydraulic apparatus 42A, etc. In the case of the present embodiment, the ECU 23A and the hydraulic apparatus 42A constitute the electric servo brake, and the ECU 23A controls, for example, the distribution of the braking force by the four brake apparatuses 51, and the braking force by regenerative braking of the motor M.

The ECU 24A is a stop maintaining control unit that controls an electric parking lock apparatus 50a provided in the automatic transmission TM. The electric parking lock apparatus 50a includes a mechanism that locks an internal mechanism of the automatic transmission TM mainly at the time of selection of a P range (parking range). The ECU 24A can control locking and unlocking by the electric parking lock apparatus 50a.

The ECU 25A is an in-vehicle notification control unit that controls an information output apparatus 43A for reporting information inside the vehicle. The information output apparatus 43A includes, for example, a display apparatus such as a head-up display, and an audio output apparatus. Further, a vibration apparatus may be included. The ECU 25A causes the information output apparatus 43A to output, for example, various kinds of information such as the vehicle speed and the outside temperature, and information of course guidance, etc.

The ECU 26A is an outside-vehicle notification control unit that controls an information output apparatus 44A for reporting information to the outside of the vehicle. In the case of the present embodiment, the information output apparatus 44A is a direction indicator (hazard lamp), and the ECU 26A can report the moving direction of the vehicle V to the outside of the vehicle by performing blinking control of the information output apparatus 44A as the direction indicator, and can enhance the attention toward the vehicle V from the outside of the vehicle by performing blinking control of the information output apparatus 44A as the hazard lamp.

The ECU 27A is a drive control unit that controls the power plant 50. In the present embodiment, although one ECU 27A is assigned to the power plant 50, one ECU may be assigned to each of the internal combustion engine EG, the motor M, and the automatic transmission TM. The ECU 27A controls the output of the internal combustion engine EG and the motor M, and switches the gear range of the automatic transmission TM, corresponding to, for example, the driver's operation detected by an operation detection sensor 34a provided in an accelerator pedal AP, and an operation detection sensor 34b provided in a brake pedal BP, the vehicle speed, etc. Note that a rotation frequency sensor 39 that detects the rotation frequency of an output shaft of the automatic transmission TM is provided in the automatic transmission TM as a sensor that detects the traveling state of the vehicle V. The vehicle speed of the vehicle V can be calculated from the detection result of the rotation frequency sensor 39.

The ECU 28A is a position recognition unit that recognizes the current position and course of the vehicle V. The ECU 28A performs control and information processing of the detection results or communication results of a gyro sensor 33A, a GPS sensor 28b, and a communication apparatus 28c. The gyro sensor 33A detects the rotary motion of the vehicle V. The course of the vehicle V can be determined from the detection result of the gyro sensor 33A, etc. The GPS sensor 28b detects the current position of the vehicle V. The communication apparatus 28c performs wireless communication with a server providing map information and traffic information, and obtains these kinds of information. A database 28a can store highly accurate map information, and the ECU 28A can specify the position of the vehicle V on a lane with a higher degree of accuracy, based on this map information, etc.

An input apparatus 45A is arranged inside the vehicle so as to be able to be operated by the driver, and receives instructions from the driver, and the input of information.

<Control Apparatus 1B>

Referring to FIG. 2, the configuration of the control apparatus 1B will be described. The control apparatus 1B includes an ECU group (control unit group) 2B. The ECU group 2B includes a plurality of ECUs 21B to 25B. Each ECU includes a processor represented by a CPU, a storage device such as a semiconductor memory, an interface with an external device, etc. The storage device stores a program executed by the processor, data used by the processor for processing, etc. Each ECU may include a plurality of processors, storage devices, interfaces, etc. Note that the number of the ECUs and the functions to be handled can be properly designed, and these can be more subdivided or integrated than in the present embodiment. Further, similar to the ECU group 2A, in FIG. 2 and FIG. 3, typical function names are assigned to the ECU 21B to 25B.

The ECU 21B is an environment recognition unit that recognizes the traveling environment of the vehicle V, based on the detection results of the detection units 31B and 32B that detect the surrounding conditions of the vehicle V, and is also a traveling support unit that performs control in connection with traveling support (in other words, driving support) as traveling control of the vehicle V. The ECU 21B generates target data, which will be described later, as peripheral environment information.

Note that, although the ECU 21B has the configuration including an environment recognition function and a traveling support function in the present embodiment, an ECU may be provided for each of the functions, such as the ECU 21A and the ECU 29A of the control apparatus 1A. Conversely, in the control apparatus 1A, one ECU may achieve the functions of the ECU 21A and the ECU 29A, such as the ECU 21B.

In the case of the present embodiment, the detection unit 31B is an imaging device (hereinafter may be denoted as the camera 31B) that detects an object around the vehicle V by imaging. The camera 31B is provided in the front portion of the roof of the vehicle V, so as to be able to image the front of the vehicle V. By analyzing of the image imaged by the camera 31B, it is possible to extract the outline of a target, and to extract the compartment lines (white lines, etc.) of lanes on a road. In the case of the present embodiment, the detection unit 32B is a millimeter wave radar that detects the object around the vehicle V by an electric wave (hereinafter may be denoted as the radar 32B), detects the target around the vehicle V, and measures the distance to the target. In the case of the present embodiment, five radars 32B are provided: one in the middle of the front portion of the vehicle V; one in each corner of the front portion; and one in each corner of the rear portion. The number and arrangement of the radars 32B can be properly selected.

The ECU 22B is a steering control unit that controls an electric power steering apparatus 41B. The electric power steering apparatus 41B includes a mechanism that steers the front wheels according to the driver's operation (steering operation) with respect to the steering wheel ST. The electric power steering apparatus 41B assists the steering operation, and includes a motor that exhibits the driving force for automatically steering the front wheels, a sensor that detects the rotation amount of the motor, a torque sensor that detects the steering torque to be exerted on the driver, etc. Additionally, a steering angle sensor 37 is electrically connected to the ECU 22B via a communication line L2 described later, and can control the electric power steering apparatus 41B based on the detection result of the steering angle sensor 37. The ECU 22B can obtain the detection result of a sensor 36 that detects whether or not the driver is gripping the steering handle ST, and can monitor the driver's gripping condition.

The ECU 23B is a braking control unit that controls a hydraulic apparatus 42B. The hydraulic apparatus 42B achieves, for example, VSA (Vehicle Stability Assist). The braking operation by the driver with respect to the brake pedal BP is converted into hydraulic pressure in the brake master cylinder BM, and is transmitted to the hydraulic apparatus 42B. The hydraulic apparatus 42B is an actuator that can control the hydraulic pressure of the working fluid to be supplied to the brake apparatus 51 for each wheel, based on the hydraulic pressure transmitted from the brake master cylinder BM, and the ECU 23B performs drive control of an electromagnetic valve provided in the hydraulic apparatus 42B, etc.

In the case of the present embodiment, the ECU 42B and the hydraulic apparatus 23B are electrically connected to a wheel speed sensor 38 provided in each of the four wheels, a yaw rate sensor 33B, and a pressure sensor 35 that detects the pressure in the brake master cylinder BM, and based on the detection results of these, an ABS function, traction control and the posture control function of the vehicle V are achieved. For example, the ECU 23B adjusts the braking force of each of the wheels based on the detection result of the wheel speed sensor 38 provided in each of the four wheels, and suppresses sliding of each of the wheels. Additionally, the braking force of each wheel is adjusted based on the rotation angular speed about a vertical axis of the vehicle V detected by the yaw rate sensor 33B, and the rapid posture change of the vehicle V is suppressed.

Additionally, the ECU 23B also functions as an outside-vehicle notification control unit that controls an information output apparatus 43B that reports information to the outside of the vehicle. In the case of the present embodiment, the information output apparatus 43B is a brake light, and the ECU 23B can turn on the brake light at the time of braking, etc. Accordingly, the attention toward the vehicle V from the following vehicle can be enhanced.

The ECU 24B is a stop maintaining control unit that controls electric parking brake apparatuses (for example, drum brakes) 52 provided in the rear wheels. The electric parking brake apparatus 52 includes a mechanism for locking the rear wheel. The ECU 24B can control locking and unlocking of the rear wheels by the electric parking brake apparatuses 52.

The ECU 25B is an in-vehicle notification control unit that controls an information output apparatus 44B that reports information inside the vehicle. In the case of the present embodiment, the information output apparatus 44B includes a display apparatus arranged in an instrument panel. The ECU 25B can cause the information output apparatus 44B to output various kinds of information, such as the vehicle speed, the fuel consumption, etc.

An input apparatus 45B is arranged inside the vehicle so as to be able to be operated by the driver, and receives instructions from the driver, and the input of information.

<Communication Lines>

Referring to FIG. 3, a description will be given of an example of communication lines of the control system 1 communicatively connecting the ECUs to each other. The control system 1 includes wired communication lines L1 to L7. Each of the ECU 20A to 27A and 29A of the control apparatus 1A is connected to the communication line L1. Note that the ECU 28A may also be connected to the communication line L1.

Each of the ECU 21B to 25B of the control apparatus 1B is connected to the communication line L2. Additionally, the ECU 20A of the control apparatus 1A is also connected to the communication line L2. The communication line L3 connects the ECU 20A and the ECU 21B to each other. The communication line L4 connects the ECU 20A and the ECU 21A to each other. The communication line L5 connects the ECU 20A, the ECU 21A, and the ECU 28A to each other. The communication line L6 connects the ECU 29A and the ECU 21A to each other. The communication line L7 connects the ECU 29A and the ECU 20A to each other.

Although the protocols of the communication lines L1 to L7 may be the same or may be different, the protocols may be different according to the communication environment, such as communication speed, traffic, and durability. For example, the communication lines L3 and L4 may be an Ethernet (registered trademark) in terms of communication speed. For example, the communication lines L1, L2 and L5 to L7 may be a CAN.

The control apparatus 1A includes a Gateway GW. The gateway GW relays the communication line L1 to the communication line L2. Therefore, for example, the ECU 21B can output a control command to the ECU 27A via the communication line L2, the gateway GW, and the communication line L1.

<Power Source>

Referring to FIG. 3, the power source of the control system 1 will be described. The control system 1 includes a large-capacity battery 6, a power source 7A, and a power source 7B. The large-capacity battery 6 is a battery for driving the motor M, and is the battery charged by the motor M.

The power source 7A is a power source that supplies electric power to the control apparatus 1A, and includes a power supply circuit 71A and a battery 72A. The power supply circuit 71A is a circuit that supplies electric power of the large-capacity battery 6 to the control apparatus 1A, and reduces, for example, the output voltage (for example, 190 V) of the large-capacity battery 6 to a reference voltage (for example, 12 V). The battery 72A is, for example, a lead battery of 12 V. By providing the battery 72A, even when the power supply of the large-capacity battery 6 and the power supply circuit 71A is cut off or decreased, electric power can be supplied to the control apparatus 1A.

The power source 7B is a power source that supplies electric power to the control apparatus 1B, and includes a power supply circuit 71B and a battery 72B. The power supply circuit 71B is a circuit similar to the power supply circuit 71A, and is a circuit that supplies electric power of the large-capacity battery 6 to the control apparatus 1B. The battery 72B is a battery similar to the battery 72A, and is, for example, a lead battery of 12 V. By providing the battery 72B, even when the power supply of the large-capacity battery 6 and the power supply circuit 71B is cut off or decreased, electric power can be supplied to the control apparatus 1B.

<Example of Control: Automated Driving>

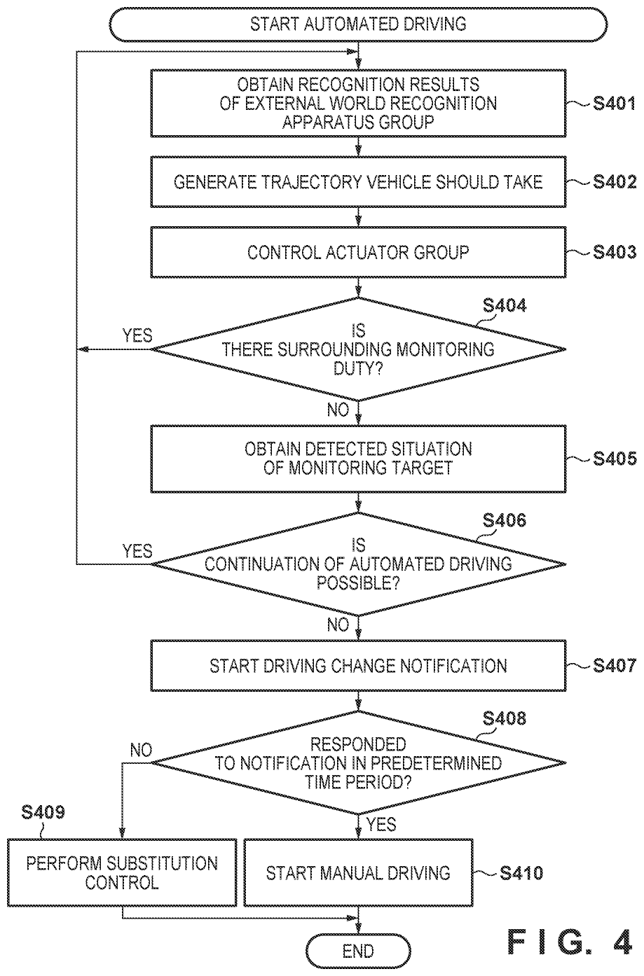

Referring to FIG. 4, a description will be given of a control method of the vehicle V by the ECU 20A and the ECU 21B during automated driving. As described above, the ECU 20A operates as a traveling control unit that performs automated driving of the vehicle V. Further, the ECU 21B operates as a monitoring unit that monitors whether traveling control by the ECU 20A is operating normally. Additionally, the ECU 21B may operate as a monitoring unit that monitors whether the substitution control by the ECU 20A is operating normally. In the following description, although the ECU 21B operates as the monitoring unit, the ECU 20A may operate as the monitoring unit, or the ECU 29A may operate as the monitoring unit. The monitoring unit that monitors the traveling control, and the monitoring unit that monitors the substitution control may be achieved by the same ECU, or may be achieved by separate ECUs. In the following description, it is assumed that the ECU 20A can operate both in the state where the driver has a surrounding monitoring duty, and in the state where the driver does not have the surrounding monitoring duty. For example, when the automated-driving level specified by the SAE (Society of Automotive Engineers) International J3016 is Level 2, it is in the state where the driver has the surrounding monitoring duty, and when the automated-driving level is Level 3, it is in the state where the driver does not have the surrounding monitoring duty. In the state without the surrounding monitoring duty, since intervention by the driver takes more time than in the state with the surrounding monitoring duty, the operation by the ECU 20A may be limited. For example, the ECU20A may operate so that lanes may be changed in the state where there is a surrounding monitoring duty, and it may operate so that lanes may not be changed in the state where there is no surrounding monitoring duty. Additionally, the upper limit of the vehicle speed by the ECU 20A in the state without the surrounding monitoring duty may be lower than the upper limit of the vehicle speed by the ECU 20A in the state with the surrounding monitoring duty.

In step S401, the ECU 20A obtains the recognition results of an external world recognition apparatus group. The external world recognition apparatus group includes, for example, the above-described camera 31A, camera 31B, lidar 32A, and radar 32B. The recognition results include the position and speed of a surrounding target, the road surface condition, etc.

In step S402, the ECU 20A generates a trajectory to be followed by the vehicle V. This trajectory may be generated on a rule basis based on the recognition results obtained in step S401.

In step S403, the ECU 20A controls an actuator group so that the vehicle V moves along the generated trajectory. The actuator group includes the above-described electric power steering apparatus 41A, electric power steering apparatus 41B, hydraulic apparatus 42A, hydraulic apparatus 42B, and power plant 50. With this, the position of the vehicle V is changed. As described above, in steps S401 to S403, the ECU 20A performs the automated driving by controlling the actuator group based on the recognition results of the external world recognition apparatus group.

In step S404, the ECU 21B determines whether or not the state of the current automated driving is the state where the driver of the vehicle V has the surrounding monitoring duty. In the case of the state with the surrounding monitoring duty (“YES” in step S404), the processing returns to step S401. In the case of the state without the surrounding monitoring duty (“NO” in step S404), the processing proceeds to step S405. In the present embodiment, since it is considered that the driver himself/herself can determine whether or not the automated driving can be continued in the case of the state with the surrounding monitoring duty, determination of whether or not the automated driving can be continued by the ECU 21B, which will be described below, is not performed. On the other hand, since it is considered that it is difficult for the driver to determine whether or not the automated driving can be continued in the case of the state without the surrounding monitoring duty, determination of whether or not the automated driving can be continued by the ECU 21B, which will be described below, is performed. Instead of this, determination of whether or not the automated driving can be continued by the ECU 21B may be performed in both of the states.

In step S405, the ECU 21B obtains information regarding a target to be monitored. In step S406, the ECU 21B determines whether or not the automated driving can be continued based on the detected situation of the target. The ECU 21B may determine whether or not the automated driving can be continued, without depending on the trajectory created by the ECU 20A. The details of processing in steps S405 and S406 will be described later. When the automated driving can be continued (“YES” in step S406), the processing returns to step S401. When the automated driving cannot be continued (“NO” in step S406), the processing proceeds to step S407, and processing for terminating the automated driving is performed.

In step S407, the ECU 20A starts a driving change notification to the driver of the vehicle V. The driving change notification is a notification to request the driver for driving change. In step S408, the ECU 20A determines whether or not the driver has responded to the driving change notification within a predetermined time period (for example, within 15 seconds). When there is no response (“NO” in S408), the processing proceeds to step S409, and when there is a response (“YES” in step S408), the processing proceeds to step S410. The driver can indicate his/her intention of shifting to manual driving with, for example, an input apparatus. Instead of this, the intention to agree may be indicated by steering detected by a steering torque sensor.

In step S409, the ECU 20A starts the automated driving with the substitution control. In the substitution control, the ECU 20A searches for a position where the vehicle V can stop, while decelerating the vehicle V. When the position where the vehicle V can stop can be found, the ECU 20A stops the vehicle V there, and when the position where the vehicle V can stop cannot be found, the ECU 20A searches for the position where the vehicle V can stop, while causing the vehicle V to travel at a very low speed (for example, creep speed). Thereafter, the ECU 20A determines whether the vehicle V is stopped from the detection result of the rotation frequency sensor 39, and upon determination that the vehicle V is stopped, the ECU 20A maintains stoppage of the vehicle V. During performance of the substitution control by ECU 20A, the ECU 21B may monitor input information that is input to the ECU 20A, and output information that is output from the ECU 20A. The input information is, for example, information regarding the state of the vehicle V, the external world information, etc. The output information is, for example, an action plan, command values to the actuators, etc. The ECU 21B may suppress performance of the substitution control by the ECU 20A, based on these sets of input information and output information. For example, the ECU 21B compares the output information that is currently output with the past output information with respect to similar input information. When there is a great difference between these sets of output information, the ECU 21B may determine that the substitution control is not normally functioning, and may terminate the substitution control by the ECU 20A. By operating in this manner, the vehicle behavior can be prevented from being unstable due to the functional deterioration of the substitution control.

In step S410, the ECU 20A terminates the driving change notification, terminates the automated driving, and starts manual driving. In manual driving, each ECU of the vehicle V will control travelling of the vehicle V according to the driver's operation. Since there is a possibility that the performance of the ECU 20A is deteriorated, etc., the ECU 20A may output, to a display apparatus 92, a message to prompt bringing of the vehicle V to a maintenance factory.

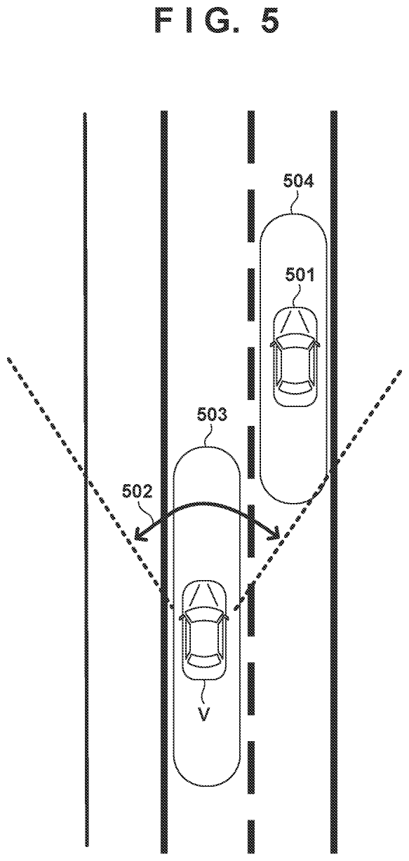

Referring to FIG. 5, the details of processing in the above-described steps S405 and S406 will be described. First, in step S405, the ECU 21B obtains the detected situation of a target to be monitored by the external world recognition apparatus group, as the control result of the actuator group in step S403. This target may be a dynamic target, such as another travelling vehicle 501, or may be a static target, such as a guardrail. The ECU 21B may set all targets that can be recognized by the external world recognition apparatus group as targets to be monitored. Instead of this, among the targets that can be recognized, the ECU 21B may use a target (for example, a target included in a range 502 of FIG. 5) located in the moving direction or movable direction of the vehicle V among as an object to be monitored. The detected situation of the target includes, for example, the type, position, and speed of the target (in the case of a dynamic target), etc.

Subsequently, step S406 will be described. First, the ECU 21B sets a self-vehicle margin 503 including the vehicle V with the vehicle V being centered. Additionally, for each target to be monitored, the ECU 21B sets a target margin including the target with this target being centered. For example, the ECU 21B sets a target margin 504 to another vehicle 501. The self-vehicle margin 503 is a range in which the safety of the vehicle V (self-vehicle) is guaranteed. The ECU 21B determines the safety of the self-vehicle based on the positional relationships between the self-vehicle margin 503 and other targets. The target margin 504 is a range in which the safety of the target is guaranteed. Although the self-vehicle margin 503 and the target margin 504 are both illustrated as substantially oval shapes in FIG. 5, these may be other shapes.

The ECU 21B may set the self-vehicle margin 503 to be the size corresponding to the operational state and type of the vehicle V. For example, the higher the speed of the vehicle V is, the larger the self-vehicle margin 503 set by the ECU 21B may be. Instead of this, the ECU 21B may set the size of the self-vehicle margin 503 according to the relative speed with respect to the target. For example, the higher the relative speed with respect to the target is, the larger the self-vehicle margin 503 set by the ECU 21B may be. Similarly, the ECU 21B may set the target margin 504 to be the size corresponding to the operational state and type of the target. For example, the ECU 21B may make the size of the target margin 504 for a static target smaller than the size of the target margin for a dynamic target.

Subsequently, the ECU 21B determines whether or not the automated driving can be continued based on the distance or the interference degree between the self-vehicle margin 503 and the target margin 504. For example, when the self-vehicle margin 503 and the target margin 504 do not overlap each other, the ECU 21B determines that the automated driving can be continued, and when the self-vehicle margin 503 and the target margin 504 overlap each other (as illustrated in FIG. 5), the ECU 21B determines that the automated driving cannot be continued. Instead of this, when the overlapping amount (hereinafter referred to as the lap amount) between the self-vehicle margin 503 and the target margin 504 is equal to or less than a threshold value, the ECU 21B may determine that the automated driving can be continued, and when the overlapping amount is larger than the threshold value, the ECU 21B may determine that the automated driving cannot be continued. Further, the ECU 21B may monitor the time change rate of the lap amount. For example, even when the automated driving is operating normally, the lap amount may temporarily exceed the threshold value due to interruption by another vehicle 501, etc. Therefore, the ECU 21B monitors the time change of the lap amount for a predetermined period (for example, three seconds), after the lap amount exceeds the threshold value. When the lap amount is decreased, the ECU 21B may determine that the automated driving can be continued. On the other hand, when the lap amount is increased, the ECU 21B may determine that the automated driving cannot be continued. The ECU 21B may determine the length of the predetermined period for monitoring the time change of the lap amount, according to the operational state and type of the vehicle V, and the relative velocity of the vehicle V with respect to another vehicle 501. For example, when the speed of the vehicle V or the relative speed of the vehicle V with respect to another vehicle 501 is high, since there is a possibility that the time until both the vehicle V and another vehicle 501 collide to each other is short, the ECU 21B decreases the length of the predetermined period (for example, one second). On the other hand, when the speed of the vehicle V or the relative speed of the vehicle V with respect to another vehicle 501 is low, the ECU 21B increases the length of the predetermined period (for example, five seconds).

In the above-described example, the self-vehicle margin 503 and the target margin 504 are set, and whether or not the automated driving can be continued is determined based on these margins. Instead of this, the ECU 21B may determine whether or not the automated driving can be continued, based on the distance between the vehicle V and the target. For example, when the distance between the vehicle V and the target becomes equal to or less than a threshold value TH2, the ECU 21B may determine that the automated driving cannot be continued, and when the distance is larger than the threshold value TH2, the ECU 21B may determine that the automated driving can be continued. Further, the ECU 20A may perform an operation for suppressing occurrence of such a situation. For example, the ECU 21B may control the actuator group to increase this distance, when the distance between the vehicle V and the target becomes equal to or less than a threshold value TH1. Here, the threshold value TH2 is a value smaller than the threshold value TH1. Even when the actuator group is controlled to increase the distance to the target, in the case where this distance is shortened, there is a possibility that the performance of the automated-driving function is deteriorated, and thus the ECU 21B determines that the automated driving cannot be continued.

As described in FIG. 4, when it is determined that the automated driving can be continued in step S406, the processing is repeated from step S401. That is, the processing in step S401 to step S406 is periodically performed. Therefore, the ECU 21B will periodically detect the distance between the vehicle V and the target. In this periodic detection, after the distance between the vehicle V and the target becomes equal to or less than the threshold value TH1, when this distance is on a decreasing trend (that is, when the vehicle V continues to approach the target), the ECU 21B may determine that the automated driving cannot be continued. It is because, also in this case, there is a possibility that the performance of the automated-driving function is deteriorated.

<Example of Control: Traveling Support>

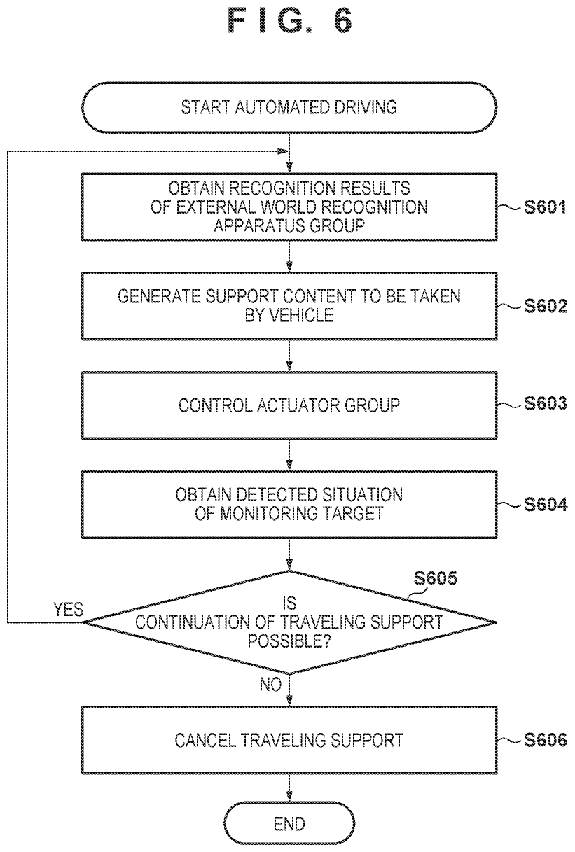

Referring to FIG. 6, a description will be given of a control method of the vehicle V by the ECU 20A and the ECU 21B during traveling support. As described above, the ECU 21B operates as the traveling control unit that performs traveling support of the vehicle V. Further, the ECU 20A operates as the monitoring unit that monitors whether traveling control by the ECU 21B is operating normally. In the following description, although the ECU 20A operates as the monitoring unit, the ECU 21B may operate as the monitoring unit, or the ECU 29A may operate as the monitoring unit. Since it is during traveling support that supports the driver's manual driving, the driver has the surrounding monitoring duty.

In step S601, as in step S401, the ECU 21B obtains the recognition results of the external world recognition apparatus group.

In step S602, the ECU 21B generates support content to be taken by the vehicle V. This support content may be generated on a rule basis based on the recognition results obtained in step S601.

In step S603, the ECU 21B controls the actuator group so that the vehicle V performs the generated support content. The actuator group includes the above-described electric power steering apparatus 41A, electric power steering apparatus 41B, hydraulic apparatus 42A, hydraulic apparatus 42B, and power plant 50. The position of the vehicle V is changed with a manual operation by the driver, and this support content. As described above, in steps S601 to S603, the ECU 21B performs traveling support by controlling the actuator group based on the recognition results of the external world recognition apparatus group.

In step S604, the ECU 20A obtains information regarding the target to be monitored. In step S605, the ECU 20A determines whether or not traveling support can be continued, based on the detected situation of the target. The ECU 20A may determine whether or not traveling support can be continued, without depending on the support content created by the ECU 21B. The details of steps S604 and S605 are the same as those of steps S405 and S406. When traveling support can be continued (“YES” in step S605), the processing returns to step S601. When traveling support cannot be continued (“NO” in step S605), the processing proceeds to step S606, and the ECU 21B cancels traveling support. In this case, travelling of the vehicle V is performed by manual driving without traveling support.

Although, in the above-described embodiment, it has been described that the ECU 20A automatically performs all of driving, braking and steering as automated driving control in the automated-driving state, the automated driving control may control at least one of driving, braking or steering without the driver's driving operation. Controlling without the driver's driving operation can include controlling without an input by the driver with respect to an operator represented by a steering handle, a pedal, or can be said that the intention of the driver to drive the vehicle is not essential. Accordingly, automated driving control may be in the state where the driver has a surrounding monitoring duty, and at least one of driving, braking or steering of the vehicle V is controlled according to peripheral environment information of the vehicle V, may be in the state where the driver has the surrounding monitoring duty, and at least one of driving or braking, and steering of the vehicle V is controlled according to the peripheral environment information of the vehicle V, or may be in the state where the driver does not have the surrounding monitoring duty, and all of driving, braking and steering of the vehicle V are controlled according to the peripheral environment information of the vehicle V. Additionally, transition to each of these control stages can be made possible. In addition, a sensor that detects the driver's state information (biological information such as heart rate, state information such as expression and pupils) may be provided, and automated driving control may be performed, or may be suppressed according to the detection result of the sensor.

On the other hand, the driving support control (alternatively, traveling support control) performed by the ECU 29A and the ECU 21B may control at least one of driving, braking or steering during the driver's driving operation. During the driver's driving operation can be said as the case where there is an input by the driver with respect to an operator, or the case where the driver's contact to the operator can be confirmed, and the intention of the driver to drive the vehicle can be read. The driving support control can include both the driving support control performed by selecting activation of the driving support control through the driver's switch operation, and the driving support control performed without the driver's selection of activation of the driving support control. As for the former control, the activation of which is selected by the driver, preceding car tracking control, lane maintaining control, etc. can be listed. These can also be defined as a part of automated driving control. As for the latter control performed without the driver's selection of activation of the control, collision mitigation brake control, lane deviation suppression control, erroneous start suppression control, etc. can be listed.

### Summary of Embodiments

### [Configuration 1]

A control system (1) of a vehicle (V) including an external world recognition apparatus group (31A, 31B, 32A and 32B) and an actuator group (41A, 41B, 42A, 42B and 50), the control system (V) comprising:
a traveling control unit (20A, 21B) configured to perform automated driving or traveling support by controlling the actuator group based on recognition results of the external world recognition apparatus group; and
a monitoring unit (20A, 21B) configured to monitor a detected situation of a target (501) by the external world recognition apparatus group as a control result of the actuator group,
wherein the monitoring unit determines whether or not the automated driving or the traveling support can be continued, based on the detected situation of the target.

According to this configuration, by monitoring the behavior of the vehicle that will not be performed when the traveling control function is operating normally, deterioration of the traveling control function of the vehicle can be accurately determined.

### [Configuration 2]

The control system according to Configuration 1, wherein when the monitoring unit determines that the automated driving or the traveling support cannot be continued, the traveling control unit performs processing for terminating the automated driving or the traveling support.

According to this configuration, it is possible to perform switching to manual driving in the case of the automated driving, and to perform switching to fully manual driving in the case of the manual driving.

### [Configuration 3]

The control system according to Configuration 2, wherein the processing includes requesting a driver of the vehicle for driving change, and performing substitution control when the driving change is not performed.

According to this configuration, the vehicle can be shifted to a safe state.

### [Configuration 4]

The control system according to Configuration 3, wherein
the monitoring unit is a first monitoring unit,
the control system further comprises a second monitoring unit configured to monitor, during performance of the substitution control by the traveling control unit, input information that is input to the traveling control unit, and output information that is output from the traveling control unit, and
the second monitoring unit suppresses performance of the substitution control by the traveling control unit based on the input information and the output information.

According to this configuration, by monitoring the input and output of the substitution control, the vehicle behavior can be prevented from being unstable due to the functional deterioration of the substitution control.

### [Configuration 5]

The control system according to any one of Configurations 1 to 4, wherein
when a distance between the vehicle and the target becomes equal to or less than a first threshold value, the traveling control unit controls the actuator group to increase the distance, and
when the distance between the vehicle and the target becomes equal to or less than a second threshold value smaller than the first threshold value, the monitoring unit determines that the automated driving or the traveling support cannot be continued.

According to this configuration, by monitoring the approach that cannot take place in normal traveling control, the functional deterioration of traveling control can be determined.

### [Configuration 6]

The control system according to Configuration 5, wherein the monitoring unit periodically detects the distance between the vehicle and the target.

According to this configuration, the functional deterioration can be detected with a higher accuracy by performing periodic detection. For example, excessive reaction to temporary interruption, etc. can be suppressed.

### [Configuration 7]

The control system according to any one of Configurations 1 to 4, wherein the monitoring unit periodically detects the distance between the vehicle and the target, and
after the distance between the vehicle and the target becomes equal to or less than the first threshold value, when the distance is on a decreasing trend, the traveling control unit determines that the automated driving or the traveling support cannot be continued.

According to this configuration, the functional deterioration can be detected with a higher accuracy by performing periodic detection. For example, excessive reaction to temporary interruption, etc. can be suppressed.

### [Configuration 8]

The control system according to any one of Configurations 1 to 4, wherein the monitoring unit sets a self-vehicle margin (503) including the vehicle with the vehicle being centered, and a target margin (504) including the target with the target being centered, and determines whether or not the automated driving or the traveling support can be continued, based on the distance or an interference degree between the self-vehicle margin and the target margin.

According to this configuration, by comparing the margins, the functional deterioration can be detected with a sense of security.

### [Configuration 9]

The control system according to Configuration 8, wherein the monitoring unit sets the self-vehicle margin or the target margin to be a size corresponding to an operational state and a type.

According to this configuration, detection corresponding to the operational state and the type can be performed.

### [Configuration 10]

The control system according to any one of Configurations 1 to 9, wherein the monitoring unit determines whether or not the automated driving or the traveling support can be continued, without depending on a trajectory created by the traveling control unit.

According to this configuration, it is possible to detect the functional deterioration that cannot be detected when depending on the trajectory created by the traveling control unit.

### [Configuration 11]

The control system according to any one of Configurations 1 to 10, wherein the monitoring unit uses a target located in a moving direction or a movable direction of the vehicle as an object to be monitored.

According to this configuration, it is possible to exclude the range that cannot be handled, such as behind the self-vehicle.

### [Configuration 12]

The control system according to any one of Configurations 1 to 11, wherein
the traveling control unit can operate in a first state where a driver has a surrounding monitoring duty, and a second state where the driver does not have the surrounding monitoring duty, and
the monitoring unit does not determine whether or not the automated driving or the traveling support can be continued in the first state, and determines whether or not the automated driving or the traveling support can be continued in the second state.

According to this configuration, determination of the functional deterioration can be given to the driver in the case with the surrounding monitoring duty, and the functional deterioration can be automatically determined in the case without the surrounding monitoring duty.

### [Configuration 13]

The control system according to Configuration 12, wherein
the traveling control unit operates so as to change lanes in the first state, and operates so as not to change lanes in the second state, and
an upper limit of vehicle speed by the traveling control unit in the second state is lower than the upper limit of the vehicle speed by the traveling control unit in the first state.

According to this configuration, it is possible to reduce the false positive risk in determination of the functional deterioration of traveling control. Specifically, in the case where the driver has the surrounding monitoring duty, even when the control system detects a false positive, the driver can quickly perform operation intervention with respect to vehicle control. In the case where the driver does not have the surrounding monitoring duty, since the travel speed is low, the automated-driving level is high, and traffic participants are limited, the control system can perform traveling control in the state where the false positive risk is reduced. Additionally, when the driver does not have the surrounding monitoring duty, since the control system does not change lanes, the control system can quickly determine that malfunction is performed by detecting deviation from a lane.

### [Configuration 14]

A vehicle (V) comprising:
the control system according to any one of Configurations 1 to 13;
the external world recognition apparatus group; and the actuator group.

According to this configuration, deterioration of the traveling control function of the vehicle can be accurately determined.

### [Configuration 15]

A control method of a vehicle (V) including an external world recognition apparatus group (31A, 31B, 32A and 32B) and an actuator group (41A, 41B, 42A, 42B and 50), the control method comprising:
performing (S401 to S403, S601 to S603) automated driving or traveling support by controlling the actuator group based on recognition results of the external world recognition apparatus group;
monitoring (S405, S604) a detected situation of a target (501) by the external world recognition apparatus group as a control result of the actuator group; and
determining (S406, S605) whether or not the automated driving or the traveling support can be continued, based on the detected situation of the target.

According to this configuration, by monitoring the behavior of the vehicle that will not be performed when the traveling control function is operating normally, deterioration of the traveling control function of the vehicle can be accurately determined.

The present invention is not limited to the above embodiments, and various changes and modifications can be made without departing from the spirit and scope of the present invention. Therefore, to apprise the public of the scope of the present invention, the following claims are attached.

1. A control system of a vehicle including an external world recognition apparatus group and an actuator group, the control system comprising:
a traveling control unit configured to perform automated driving or traveling support by controlling the actuator group based on recognition results of the external world recognition apparatus group; and
a monitoring unit configured to monitor a detected situation of a target by the external world recognition apparatus group as a control result of the actuator group,
wherein the monitoring unit determines whether or not the automated driving or the traveling support can be continued, based on the detected situation of the target.

2. The control system according to claim 1, wherein when the monitoring unit determines that the automated driving or the traveling support cannot be continued, the traveling control unit performs processing for terminating the automated driving or the traveling support.

3. The control system according to claim 2, wherein the processing includes requesting a driver of the vehicle for driving change, and performing substitution control when the driving change is not performed.

4. The control system according to claim 3, wherein
the monitoring unit is a first monitoring unit,
the control system further comprises a second monitoring unit configured to monitor, during performance of the substitution control by the traveling control unit, input information that is input to the traveling control unit, and output information that is output from the traveling control unit, and
the second monitoring unit suppresses performance of the substitution control by the traveling control unit based on the input information and the output information.

5. The control system according to claim 1, wherein
when a distance between the vehicle and the target becomes equal to or less than a first threshold value, the traveling control unit controls the actuator group to increase the distance, and
when the distance between the vehicle and the target becomes equal to or less than a second threshold value smaller than the first threshold value, the monitoring unit determines that the automated driving or the traveling support cannot be continued.

6. The control system according to claim 5, wherein the monitoring unit periodically detects the distance between the vehicle and the target.

7. The control system according to claim 1, wherein
the monitoring unit periodically detects the distance between the vehicle and the target, and
after the distance between the vehicle and the target becomes equal to or less than the first threshold value, when the distance is on a decreasing trend, the traveling control unit determines that the automated driving or the traveling support cannot be continued.

8. The control system according to claim 1, wherein the monitoring unit sets a self-vehicle margin including the vehicle with the vehicle being centered, and a target margin including the target with the target being centered, and determines whether or not the automated driving or the traveling support can be continued, based on the distance or an interference degree between the self-vehicle margin and the target margin.

9. The control system according to claim 8, wherein the monitoring unit sets the self-vehicle margin or the target margin to be a size corresponding to an operational state and a type.

10. The control system according to claim 1, wherein the monitoring unit determines whether or not the automated driving or the traveling support can be continued, without depending on a trajectory created by the traveling control unit.

11. The control system according to claim 1, wherein the monitoring unit uses a target located in a moving direction or a movable direction of the vehicle as an object to be monitored.

12. The control system according to claim 1, wherein
the traveling control unit can operate in a first state where a driver has a surrounding monitoring duty, and a second state where the driver does not have the surrounding monitoring duty, and
the monitoring unit does not determine whether or not the automated driving or the traveling support can be continued in the first state, and determines whether or not the automated driving or the traveling support can be continued in the second state.

13. The control system according to claim 12, wherein
the traveling control unit operates so as to change lanes in the first state, and operates so as not to change lanes in the second state, and
an upper limit of vehicle speed by the traveling control unit in the second state is lower than the upper limit of the vehicle speed by the traveling control unit in the first state.

14. A vehicle comprising:
the control system according to claim 1;
the external world recognition apparatus group; and
the actuator group.

15. A control method of a vehicle including an external world recognition apparatus group and an actuator group, the control method comprising:
performing automated driving or traveling support by controlling the actuator group based on recognition results of the external world recognition apparatus group;
monitoring a detected situation of a target by the external world recognition apparatus group as a control result of the actuator group; and
determining whether or not the automated driving or the traveling support can be continued, based on the detected situation of the target.
